(19) United States
(12) Patent Application Publication
(10) Pub. No.: US 2010/0055267 A1
(43) Pub. Date: Mar. 4, 2010

(54) Method of Producing a Shelf-Stable Citrus Spray-Dry Product

(76) Inventors: Lewis Michael Popplewell, Morganville, NJ (US); Lulu Henson, Plainsboro, NJ (US); Adam J. Toth, Aberdeen, NJ (US)

Correspondence Address: INTERNATIONAL FLAVORS & FRAGRANCES INC., 521 WEST 57TH ST, NEW YORK, NY, 10019, US

(21) Appl. No.: 12/201,003

(22) Filed: Aug. 29, 2008

(51) Int. Cl. A23L 2/42; A23L 3/00; A23L 2/39

(52) U.S. Cl. 426/325; 426/324; 426/410; 426/590

(57) ABSTRACT

The present invention relates generally to storage-stable, citrus-flavored compositions and to methods for their preparation.

### FIELD OF THE INVENTION

The present invention relates generally to storage-stable, citrus-flavored compositions and to methods for their preparation. In particular, the invention relates to storage-stable foods and beverages containing citrus oils as the flavoring agent.

### BACKGROUND OF THE INVENTION

The following invention is directed to maintaining the quality of spray-dried citrus flavors during storage and subsequent use in powdered soft drink and similar dry mix applications. Spray drying flavors provides several functionalities; (1) provides a means to deliver liquid flavors or essential oils in a dry delivery system so that it can be used in dry applications; and (2) flavor materials are made more stable through encapsulation, thus extending their shelf-life. Citrus flavors however, are particularly sensitive to oxidative changes even after spray drying, especially during high temperature storage, resulting in the formation of off-flavor compounds. These oxidation products generally have low odor and flavor thresholds, such that flavor quality is impaired even when minor amounts are formed. Spray-dried non-citrus fruit flavors may also undergo decomposition during storage; however, the characterizing flavor compounds tend to be volatile and will more likely evaporate from the spray dry before the flavor compounds have had the chance to undergo oxidative decomposition. Hence, compared to non-citrus flavored products, citrus flavored products tend to have a shorter shelf-life.

It has been found that it is possible to maintain spray-dry citrus flavor quality by providing conditions that will maintain or reduce the water activity of the spray dry during storage such that the concentration of limonene oxide, carveol, and carvone are kept below the levels required for sensory significance.

A need therefore exists for a method for improving the stability and shelf life of citrus-flavored compositions, particularly citrus-flavored foods and beverages.

### SUMMARY OF THE INVENTION

The present invention is directed a method of providing a shelf-stable citrus-flavored beverage wherein the levels of perceived off-flavor intensity contributed by oxidation compounds such as but not limited to limonene oxide, carveol and carvone are present at a level below sensory significance.

In one embodiment, the invention is directed to providing a shelf-stable spray-dried citrus-flavor composition wherein the composition is stored in a low humidity environment.

In a further embodiment a shelf-stable citrus-flavored powdered soft drink is provided wherein the spray-dried flavor that is added to the powdered soft drink has been stored for an extended period of time in a low humidity environment and at an elevated temperature.

In a preferred embodiment, a shelf-stable citrus-flavor composition is provided wherein the spray-dried citrus-flavor is stored in a vacuum sealed package.

In yet another embodiment, a shelf-stable citrus-flavored powdered soft drink is provided by mixing or contacting the spray-dried flavor with materials that can absorb moisture and can maintain or reduce the relative humidity within the packaging environment during storage.

Other features and advantages of the present invention will become apparent from the following detailed descriptions. It should be understood, however, that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1. A graph of the orange spray dry flavor moisture sorption isotherm based on Table 2 data.

FIG. 2. A graph of the changes in off flavor intensity of an orange spray dried flavor during storage in 3-mil poly bags.

FIG. 3. A graph of the changes in carveol concentration in an orange spray dried flavor during storage in 3-mil poly bags.

FIG. 4. A graph demonstrating the relationship between moisture content and water activity (a_{w}) of food materials

FIG. 5. Reaction Schematic of the Oxidation of limonene

### DETAILED DESCRIPTION OF THE INVENTION

The present invention relates to storage-stable, citrus-flavored spray-dry compositions and to methods for their preparation.

As used herein, “storage-stable” or “shelf-stable” means that the stability of the flavor system is improved under controlled physical conditions relative to the stability of the flavor system without controlled physical conditions.

Citrus flavor stabilization in accordance with the present invention is effective with citrus-flavored compositions. In a preferred embodiment of the invention, the level of the oxidation compounds, limonene oxide, carveol, and carvone concentrations, are kept below the levels for sensory significance.

In a particular embodiment, the concentration levels of limonene oxide, carveol, and carvone in a spray-dry flavor can be kept below sensory significance by controlling the environment to minimize water activity changes in the spray-dry, thereby the shelf-life of the spray-dry can be significantly extended.

In a further embodiment of the invention, packaging materials with low permeability to water vapor and oxygen can be used to maintain flavor stability by keeping the water activity of a spray dry flavor below a critical level during storage at elevated temperature and high relative humidity. By maintaining low water activity, the levels of limonene oxide, carveol, and carvone can be kept below sensory significance. A preferred method of maintaining low water activity is by storing the spray-dry in a vacuum sealed bag.

In a further embodiment of the invention, the benefits of maintaining low water activity during bulk storage of the spray-dry flavor can also continue on and show benefit during storage in commercial packaging of a powdered soft drink market product.

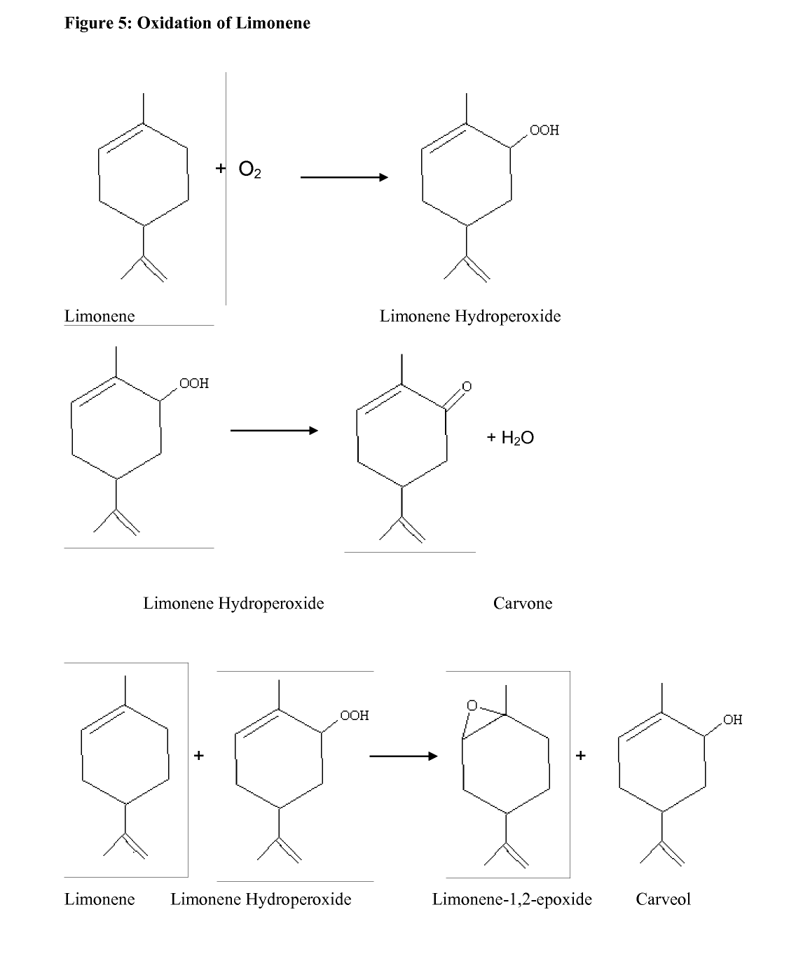

Citrus flavors generally consist of various mixtures of essential oils and top-notes or flavor compounds consisting of mixtures of aldehydes, ketones, esters, among others that impart desirable and discriminate flavor profiles to various compositions. Citrus essential oils consist of a mixture of unsaturated mono- and sesquiterpenes which are highly susceptible to oxidative degradation. Oxidation of d-limonene, the major component of citrus oils, results in the formation of limonene-1,2-epoxide (cis and trans), carvone and carveol (cis and trans) that impart off-notes that can be described as soapy, painty, piney or turpentine-like, as shown in FIG. 5. The oxidation of terpenes is similar to lipid autoxidation. The hydroperoxides formed are very reactive and can decompose rapidly.

Spray-dry flavors are most often used for dry beverage or powdered soft drink products, dry mix seasonings for topical applications, soup, sauce, and gravy mixes, marinades, dessert and bakery mixes, among others. Spray-dry has advantages over other forms of flavor encapsulation due to their versatility, high flavor loading, relatively low cost, mild heat treatment, and ease of incorporation into various types of food products.

In powdered soft drinks, spray dry flavors are critically important due to the cost sensitivity of the geographical markets where they are most popularly consumed such as Asia and Latin America. Citrus is a popular flavor type.

A spray-dried flavor typically contains a mixture, from about 50% to about 80% weight percent, more preferably from about 60% to about 70% of a modified starch; from about 5% to about 30%, more preferably from about 10% to about 20% of sugar; and from about 10% to about 30%, more preferably about 20% of essential orange oil on a dry weight basis.

A typical powdered soft drink (PSD) mix, contains anywhere from about at 0.1% to about 15% of a spray-dried flavor and more preferably from about 0.5% to about 0.7% spray-dry with the remaining being the powdered soft drink mix.

Manufacturers typically require a two-year shelf life for the flavor. However, environmental conditions in these regions are detrimental to spray dry citrus flavors due to the high humidity (e.g., >60%) combined with high ambient temperature (approximately ≧30° C.) during certain times of the year.

Water activity (a_{w}), as known by one skilled in the art, is sometimes referred to as “free” or “available” water in a system that is not bound to non-aqueous constituents. It can properly be defined as the partial vapor pressure of food moisture divided by the equilibrium vapor pressure of pure water at the same temperature. The concept of water activity has been used as a dependable assessment of the microbial growth, degradative reactions and the texture and mouth feel of foods.

a_{w}=ρ/ρ₀=ERH/100
ρ=partial vapor pressure of food moisture at temperature T
ρ₀=saturation vapor pressure of pure water at T
ERH=equilibrium relative humidity at T

At a constant temperature, a plot of water content of a food versus its corresponding water activity is known as the moisture sorption isotherm. Temperature changes the water activity of a food due to changes in water binding, solute solubility and the physical state of the food matrix. Depending on the temperature, the state of the matrix could be glassy, rubbery or highly viscous. The temperature at which the matrix transitions from a glassy to a rubbery phase is known as glass transition temperature (T_{g}). Although this second-order phase transition occurs over a range, it is often referred to as an exact temperature. As temperatures are increased above the T_{g} of a food, molecular mobility is also increased and viscosity is decreased. Water activity greatly affects the glass structure of a food because as the hydrophilic components are hydrated, the food becomes more rubbery. Water is a strong plasticizer and as water activity increases, the T_{g} of the matrix decreases.

Spray-drying is a form of flavor encapsulation that allows citrus oils to remain stable for a longer period of time compared to directly plating or mixing the oil with dry carrier materials. Such materials include silicon dioxide, maltodextrins, starches, and others that have the ability to adsorb or absorb liquids. Spray-dried compositions vary greatly but typically consist of the stabilizers such as, gum acacia or modified starch, maltodextrins, and various types of sugars or polyhydric alcohols. Certain formulations may also include proteins, emulsifiers, hydrocolloids, or other types of polymers. It is believed that highly stable spray-dry flavors can be achieved by creating a highly impermeable wall around the flavor oil droplets. This can be achieved by the use of wall materials such as sugars, corn syrup solids, and low molecular weight maltodextrins.

Formulating compositions that contain a high level of these materials creates difficulties during spray drying and post process handling due to its poor flow properties, stickiness, and hygroscopic nature. Hence, spray-dried formulations tend to be a compromise between achieving long shelf life and processing and handling convenience. A typical shelf life for spray-dried single fold orange oil is about 6 to 12 months depending on the carrier matrix and if stored under recommended conditions (cool dry area; <70° F./21° C.).

It has been surprisingly found that the spray-dried flavor disclosed in the present invention maintains its flavor stability if stored in an elevated temperature but kept in a low humidity environment. As used herein a low-humidity environment is from about 0.1% to 25% relative humidity. An elevated temperature is about 40° C. and above. A preferred method of maintaining low humidity environment is by storing the spray-dry in a vacuum sealed bag

It has also been found that by maintaining a low humidity environment the levels of limonene oxide, carveol and carvone are below sensory significance. Furthermore, it has been found that by providing a low humidity environment the level of limonene oxide is less than about 400 ppm/gm of oil; the level of carveol is less than about 250 ppm/gm oil and the level of carvone is less than about 200 ppm/gm oil.

Statistical analyses of the sensory data were performed using a multivariate ANOVA. P<0.05 is considered significant, while P<0.001 is considered very significant, and P<0.0001 is considered as extremely significant. Therefore, as used herein, the sensory results that are below sensory significance have a value equal to p>0.05 as demonstrated in the Examples below.

It is also contemplated in one embodiment to combine the spray-dried flavors with food materials that are effective at reducing the water activity of a spray-dried flavor that initially contains a high level of moisture. Food materials, such as but not limited to, sodium carboxymethylcellulose (Na-CMC), silicon dioxide, and sodium chloride can be used in combination with the spray-dried flavor. It should be pointed out that it is generally very difficult to reduce the water activity of sugar containing matrices due to the high affinity of sugar to water and solution effects. A reduction may provide the safety margin necessary to maintain the storage stability of spray-dried products in the critical region.

Although the most conventional methods of flavor encapsulation are spray-dried and melt extrusion, other technologies used today include spray chilling, coacervation and inclusion complexation.

The following are provided as specific embodiments of the present invention. Other modifications of this invention will be readily apparent to those skilled in the art, without departing from the scope of this invention. As used herein, both specification and following examples all percentages are weight percent unless noted to the contrary. The term spray dry and spray-dried can be used interchangeably throughout the invention. The abbreviation mm represented millimeters, SD represents spray-dried, PSD represents powdered soft drink, RH represents relative humidity, a_{w} represents the water activity, and T_{g} represents glass transition temperature. IFF as used in the examples is understood to mean International Flavors & Fragrances Inc.

### EXAMPLE 1

The spray-dried (SD) flavor used in this study contained a mixture of modified starch, sugar and single fold essential orange oil. On a dry weight basis (d.b.), this spray-dried flavor contained:

TABLE 1
Spray dry formula

| Ingredients | % |
|---|---|
| Modified Starch | 60-70 |
| Sugar | 10-20 |
| Orange Oil | 20 |

This formula was chosen because it represents a commercial spray-dried flavor.

This product was made using standard spray dry processing techniques. First the starch and sugar were added to water (50-55° C.) and mixed until hydrated/dissolved. The temperature of the mixture was then decreased to approximately 30° C. before addition of the essential oil. Afterwards, the slurry was mixed for 20 minutes using an Arde-Barinco high shear mixer at a pressure of 60 psi in order to form an emulsion. The slurry was then fed into the spray dryer, a Niro Utility Model I with a centrifugal atomizer and a single point product collection. Dryer air temperatures were set to 380° F. (193° C.) at the inlet and 190° F. (90° C.) at the outlet.

### EXAMPLE 2

The following test was conducted to determine the relationship between moisture uptake and glass transition temperature. Exposure of the spray-dried (SD) flavor in an environment above its water activity (a_{w}) will result in moisture uptake. Water activity equals relative humidity (RH) divided by 100; RH is a measure of the moisture in the environment, whereas, a_{w} is a property of the food material.

The fresh SD (control) made in Example 1 was allowed to equilibrate at three different relative humidities before measuring their water activities using a Decagon AquaLab Model Series 3TE (Serial#799412) and their glass transition temperatures (T_{g}) using a TA Instruments Differential Scanning Calorimeter (DSC) Q1000. T_{g} measurements were taken as the inflection point in the slope of the heating curve. Prior to this test, the fresh spray dry was found to contain 0.8% moisture by Karl Fischer. For this test, saturated salt solutions of magnesium chloride, potassium carbonate and sodium chloride were set up in sealed chambers at ambient temperatures to provide relative humidities (RH) of 31%, 41% and 70%, respectively. Once equilibrated, the RH of each chamber was measured using a Fisher-Scientific Thermo-Hygro pen. Five grams of spray dry material were weighed into a 70 mm aluminum dish and spread out so that there was a thin layer of material along the entire bottom of the dish. Samples were then placed into the chambers and allowed to equilibrate, measuring the samples on a daily basis until no weight change occurred. This took approximately 3 days although samples were held for 4 days to ensure that they were equilibrated.

TABLE 2
Effect of relative humidity on moisture uptake and T_{g} of orange spray dry

| | | | | Moisture | |
|---|---|---|---|---|---|
| | | | | Content | |
| Sample | Water Activity | Water Activity | | (gm H₂O/gm | Tg |
| Code | Target | Measured | % Moisture | dry solids) | (° C.) |
| Control | Not applicable | 0.18 | 0.8 | 0.0081 | 98 |
| A | 0.31 | 0.38 | 3.5 | 0.0363 | 56 |
| B | 0.41 | 0.45 | 5.2 | 0.0549 | Not determined |
| C | 0.70 | 0.67 | 10.6 | 0.1186 | 14 |

These results (Table 2) show that as the spray dried flavors (A, B, C) absorb moisture from the environment, the T_{g} decreases. A reduction in T_{g} will result in the SD undergoing phase transition changes at a lower temperature. As storage temperature increases above the T_{g}, the spray dry will transform from an amorphous powder to a rubbery mass. At this point, molecular mobility increases which can result in loss of flavor through volatilization and an increase in oxidation reactions due to increased permeability of the SD wall structure to oxygen.

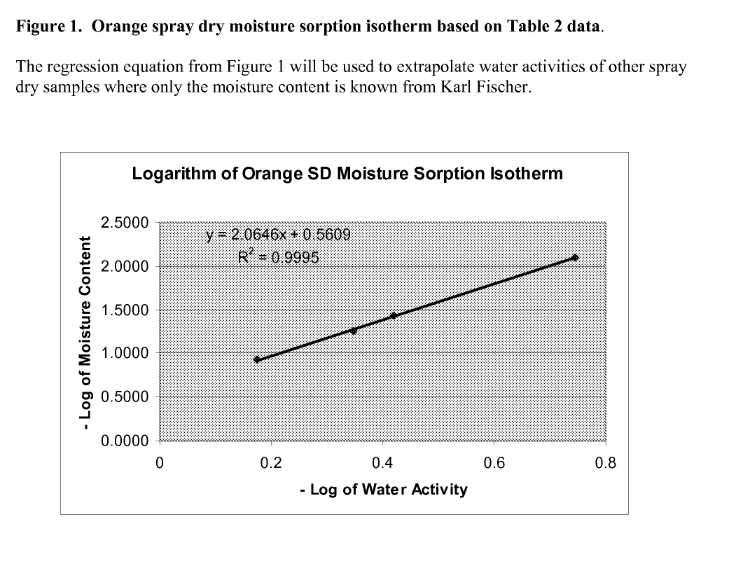

A sorption isotherm based on data from Table 2 is shown in FIG. 1.

### EXAMPLE 3

The following test was conducted to determine if the flavor stability of an orange spray dry can be maintained at an elevated temperature (40° C.) for at least 12 weeks if kept in a low humidity environment (about 25% RH). Citrus-based spray-dried flavors usually develop off-flavors within 6 to 12 months of storage under recommended storage conditions (25° C., less than 50% RH) or 6-12 weeks at accelerated storage at 40° C.

The spray dry used in the following study is comprised of the same matrix as described in Example 1. In this spray-dried flavor, the encapsulated flavor comprised of a single fold essential orange oil with added topnotes for a more acceptable sensory profile. Samples of this spray dry were stored in either 3 mil polyethylene bags or vacuum sealed Mylar® bags (with and without nitrogen flush) at both 40° C./13% RH and 35° C./80% RH. Samples were also stored in vacuum sealed Mylar® bags and then sealed in a nitrogen flushed tin can at −84° C. to be used as a frozen control and represent a “fresh” sample. Samples from all 3 storage conditions were removed after 3, 6, 9, 12 and 24 weeks. Total oil and level of oxidation compounds (limonene oxide, carveol and carvone) were determined. At the same time, pulled samples were also blended with a powdered soft drink (PSD) mix, typical of those found commercially, at 0.7% spray dry and 99.3% PSD mix. This blend was subjected to sensory testing and was also placed into commercial PSD packaging and stored at both 40° C./13% RH and 35° C./80% RH for 3, 6 and 12 weeks. At the end of each storage period, PSD samples were analyzed to determine if limonene oxide, carveol, and carvone concentrations were kept below the levels for sensory significance.

For analytical measurements, an Agilent 6890 Gas Chromatograph was used to determine total oil and oxidation compound levels. To determine total oil levels, an external standard of the neat flavor was used to create a 3 point calibration curve. In the same manner, standards of limonene oxide, carveol and carvone from Sigma-Aldrich were used to quantify oxidation levels. For the bulk spray dry analysis, samples were extracted with methanol prior to injection into the GC. For the PSD analysis, samples were first dissolved in a water/ethanol mixture, then extracted with hexane, centrifuged and injected into the GC.

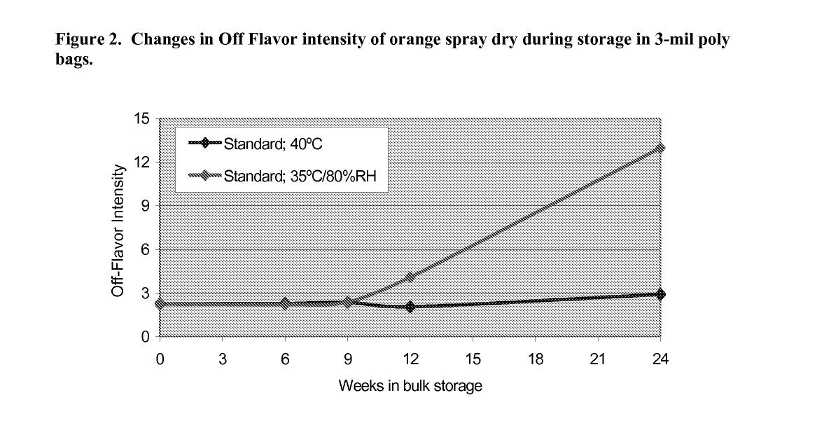

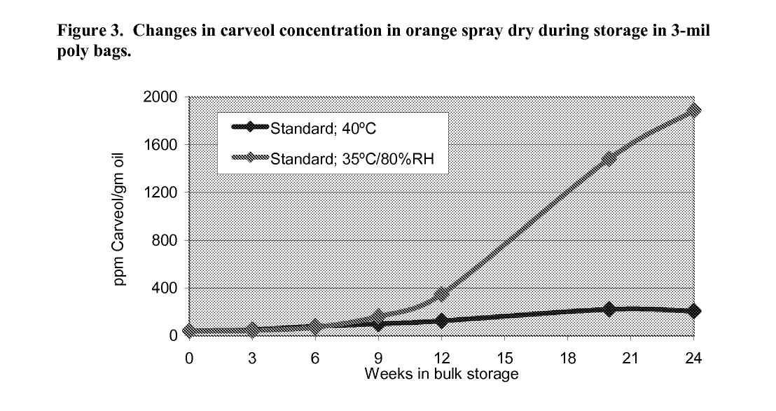

For sensory evaluation, the trained panel was instructed to use the labeled magnitude scale (LMS) to rate each sample on 7 attributes (Overall Orange Aroma, Off Odors, Sweetness, Sourness, Bitterness, Overall Orange Flavor, and Off Flavors). For evaluation of the bulk spray dry, there were a total of 7 samples rated in duplicate sets during a testing session. For evaluation of the stored PSD samples, there were a total of 10 different samples where only 4 samples were replicated so that panelists had a single set of 14 samples during a testing session. In each session, a freshly prepared PSD with the frozen control spray dry was used as a reference sample. A blind fresh sample (same as the reference) was also included in each set of testing samples. Panelists smelled and tasted all testing samples and rated their intensities, one by one, in a balanced order among panelists using a Williams' Latin Square design. Panelists took a 3-minute break and rinsed their mouths with water between samples. Each of the tests was replicated in a separate session about a week apart. In individual tests, duplicated samples/sets were treated as replications. If there was no significant replication effect, the replicated data were pooled. For replicated tests, two tests were combined and treated as sets. A multivariate ANOVA with the 7 attribute ratings as dependent variables and panelists, samples, and sets as independent variables with all their interactions. A Duncan multiple comparison method was used to determine if there were significant differences from each other among all the testing samples. Among the various attributes, Off Flavor was found to be most highly correlated to the changes in the level of oxidation compounds (see comparison of FIG. 2 and FIG. 3).

TABLE 3
Effect of storage conditions on spray dry stability after 24 weeks in 3 mil poly bags

| | | | | | | | | Off |
|---|---|---|---|---|---|---|---|---|
| | | | | | | | | Flavor |
| | | | | | Limonene | | | Intensity |
| | | % | | % | Oxide | Carveol | Carvone | p- |
| Sample | Storage | Moisture | Water | Total | (ppm/gm | (ppm/gm | (ppm/gm | value** |
| Code | Conditions | Content | Activity | Oil | oil) | oil) | oil) | (Sensory) |
| Control | Freezer | 2.2 | 0.21 | 19.4 | 61 | 40 | 30 | — |
| D | 40° C./ | 0.78 | 0.18* | 18.8 | 305 | 197 | 155 | 0.11 |
| | 13% RH | | | | | | | |
| E | 35° C./ | 5.2 | 0.45* | 10.9 | 1610 | 1886 | 1742 | <0.001 |
| | 80% RH | | | | | | | |

*Extrapolated from FIG. 1.
**For Off Flavors as compared to freezer-stored control.

The sample (D) stored at low humidity and elevated temperature was unexpectedly stable for at least 24 weeks (Table 3 and FIGS. 2 and 3). In particular, significantly lower amounts of limonene oxide, carveol, and carvone were formed in Sample D as compared to Sample E. Hence, by carefully controlling the environment to minimize water activity changes in the spray dry, the shelf life of the spray dry can be significantly extended.

These results also show that when the spray dry sample (E) was stored at a temperature (35° C.) below its T_{g}, but at a relative humidity (80% RH) above its initial a,, moisture was absorbed with a corresponding increase in its a_{w}. This increase is expected to result in a decrease in T_{g} as indicated in Example 2. The reduction in total oil content of Sample B may be attributed to an increase in the porosity of the SD wall structure as T_{g} is reduced. This resulted in the formation of significantly higher levels of oxidation compounds that were easily detected by the trained sensory panel.

### EXAMPLE 4

The following test was conducted to determine if the flavor stability of the orange spray dry can be maintained during high humidity and elevated temperature storage by the use of high barrier packaging materials. The following samples are from the bulk spray dry storage study that was described in Example 3.

TABLE 4
Properties of packaging materials*

| | O₂ | |
|---|---|---|
| | Transmission Rate | Water Vapor Transmission Rate |
| Packaging Type | (cc/100 in²/24 hrs) | (gm/100 in²/24 hrs) |
| 3 mil Poly Bag | 183 | 0.43 |
| Vacuum Bag | 0.00004 | 0.003 |

*Reference: Uline (Poly) and Impak Corp. (Vacuum)

TABLE 5
Effect of packaging material on spray dry stability during storage at 35 C/80% RH

| | | | | Limonene | | | Off Flavor |
|---|---|---|---|---|---|---|---|
| | | % | | Oxide | Carveol | Carvone | Intensity |
| Storage | Packaging | Moisture | Water | (ppm/gm | (ppm/gm | (ppm/gm | p-value** |
| Time | Type | Content | Activity* | oil) | oil) | oil) | (Sensory) |
| 12 wks | 3 mil | 5.6 | 0.48 | 643 | 348 | 279 | <0.001 |
| | Poly Bag | | | | | | |
| 12 wks | Vacuum | 1.7 | 0.26 | 76 | 44 | 34 | 0.133 |
| | Bag | | | | | | |
| 24 wks | 3 mil | 5.2 | 0.46 | 1610 | 1886 | 1742 | <0.001 |
| | Poly Bag | | | | | | |
| 24 wks | Vacuum | Not | Not | 54 | 52 | 18 | 0.187 |
| | Bag | determined | determined | | | | |

*Extrapolated from FIG. 1.
**For Off Flavors as compared to freezer-stored control.

The results show that packaging materials with low permeability to water vapor and oxygen can be used to maintain flavor stability by keeping the a_{w} of a SD below a critical level during storage at elevated temperature and high relative humidity. By maintaining a_{w}, the levels of limonene oxide, carveol, and carvone can be kept below sensory significance.

### EXAMPLE 5

The following test was conducted to determine whether flavor stability of the spray dry in a PSD mix can be maintained during storage at elevated temperature (35° C.) and high humidity (80% RH). The spray dry used in the test was previously stored at 35° C./80% RH for 12 weeks either in a vacuum or poly bag. Each sample was compared to a freezer-stored spray-dried flavor.

TABLE 6
Effect of further storage of 12 week old bulk SD with PSD
mix @ 35° C./80% RH in commercial multilayer bag

| Packaging | | Limonene | | | Off Flavor |
|---|---|---|---|---|---|
| Type | Storage | Oxide | Carveol | Carvone | Intensity |
| (during bulk | Time in | (ppm/gm | (ppm/gm | (ppm/gm | p-value* |
| storage) | PSD | SD) | SD) | SD) | (Sensory) |
| 3 mil Poly Bag | 12 wks | 262 | 992 | 692 | <0.001 |
| Vacuum Bag | 12 wks | 147 | 573 | 464 | 0.417 |

*For Off Flavors as compared to freezer-stored control.

These results show the benefits of maintaining low a_{w} during bulk storage of the SD which carries through storage in commercial packaging of a market product. Data in Table 5 shows how the a_{w} of the SD is affected by the packaging material during bulk storage at an elevated relative humidity. Since the a, of the SD in the vacuum bag was maintained during the 12-week bulk storage, levels of limonene oxide, carveol, and carvone were maintained below sensory significance (p=0.417) after an additional 12 wks of storage in the PSD mix.

### EXAMPLE 6

The following tests were conducted to determine whether combining food materials with the spray-dry will minimize changes to the water activity of spray dry during storage at high humidity.

A. The first test was to measure the effect of water uptake on the a_{w} of various food materials. Both sodium carboxymethylcellulose (Na-CMC) and silicon dioxide (SiO₂) were mixed with different levels of water and their water activities measured using a Decagon AquaLab Model Series 3TE.

TABLE 7
Effect of water uptake on the a_{w} of food materials

| Ratio of Food | | |
|---|---|---|
| Materials to Water | a_{w} of Na-CMC | a_{w} of SiO₂ |
| 100:0 | 0.16 | 0.26 |
| 95:5 | 0.43 | 0.73 |
| 90:10 | 0.59 | 0.79 |
| 85:15 | 0.70 | 0.88 |
| 80:20 | 0.79 | >0.88 |
| 75:25 | 0.82 | >0.88 |
| 70:30 | 0.87 | >0.88 |

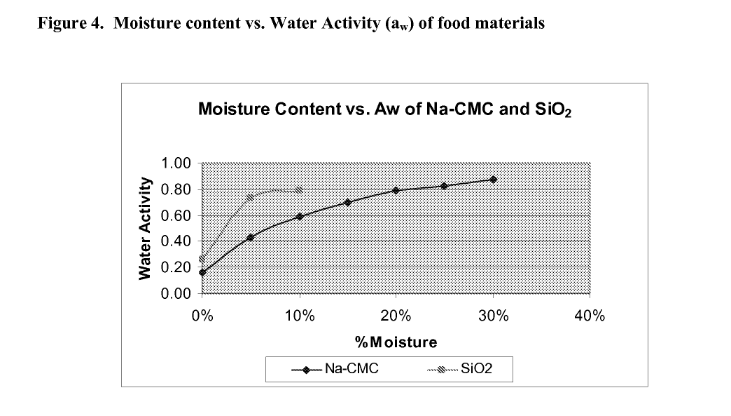

The results show that although both food materials absorbed moisture, Na-CMC is able to maintain a lower a, than silicon dioxide at the same moisture content (FIG. 4). This is especially critical in the region below 10% moisture. Spray dry materials in previous examples where shown to gain up to about 5% moisture after about 12 weeks at 80% RH @35° C. in 3 mil poly bag packaging.

B. The following test was conducted to determine if food materials, like those described in Example 6A, can absorb moisture from a SD with a high moisture content and a_{w} in order to decrease the a_{w} of the final mix.

The spray dry from Example 1 was allowed to equilibrate at 41% RH as described in Example 2. Once equilibrated, the spray dry sample was mixed with silicon dioxide, Na-CMC and sodium chloride in the following weight ratios: 95% Humidified SD+5% Material; and 75% Humidified SD+25% Material. Samples were then tested to measure their water activities using a Decagon AquaLab Model Series 3TE.

TABLE 8
Effect of food materials on a_{w} of humidified spray dry

| Ratio of Humidified | Water Activity | | |
|---|---|---|---|
| SD to Food Materials | Na-CMC | SiO₂ | NaCl |
| 100:0 | 0.41 | 0.41 | 0.41 |
| 95:5 | 0.35 | 0.40 | 0.40 |
| 75:25 | 0.26 | 0.36 | 0.40 |

These results show that some food materials are effective at reducing the a, of a SD that initially contains a high level of moisture. In this test, Na-CMC was the most effective, followed by silicon dioxide, while the addition of sodium chloride had no effect on a_{w}. It should be pointed out that it is generally very difficult to reduce the a_{w} of sugar containing matrices due to the high affinity of sugar to water and solution effects. A reduction of a_{w} from 0.41 to 0.35 by the addition of 5% Na-CMC is a significant change as a 0.06 reduction may provide the safety margin necessary to maintain the storage stability of spray dry products in the critical region.

C. The following test was conducted to determine if mixing food materials with the SD will minimize changes in water activity when the mixture is exposed to high humidity. The spray dry from Example 1 was mixed with silicon dioxide, Na-CMC, and sodium chloride in the following ratio: 95% SD+5% Material. Once mixed, these samples were allowed to equilibrate at 41% RH as described in Example 2. Samples were then tested to measure their water activities using a Decagon AquaLab Model Series 3TE.

TABLE 9
Effect of elevated RH on mixtures of food materials and spray dry

| | % | Moisture | Water |
|---|---|---|---|
| Sample | Moisture | (gm/gm dry solids) | Activity |
| Control | 4.36 | 0.0456 | 0.41 |
| 95% Control + 5% SiO₂ | 4.13 | 0.0431 | 0.26 |
| 95% Control + 5% Na-CMC | 4.48 | 0.0469 | 0.17 |
| 95% Control + 5% NaCl | 4.07 | 0.0425 | 0.33 |

These results show the ability of food materials to effectively reduce the water activity of a SD mix when exposed to an elevated humidity above the a_{w} of the initial SD. In this test it is clear that Na-CMC is the most effective at maintaining a low a_{w} of the SD even though a high level of moisture was absorbed. This means that this food material can absorb and bind moisture so that it is not available for the SD to absorb, therefore effectively maintaining a low a_{w} and perhaps a high T_{g}.

We claim:

1. A method for maintaining the flavor stability of a spray-dried citrus flavor comprising the steps of:
providing a spray-dried citrus-flavored composition;
adding the spray-dried citrus-flavored composition to a vacuum sealed bag;
providing a low humidity environment within the vacuum sealed bag; and
storing the spray-dried citrus-flavored composition in the vacuum sealed bag for an extended period of time.

2. The method of claim 1 wherein the spray-dried citrus flavor comprises a citrus flavor, sugar and a stabilizer.

3. The method of claim 2 wherein the stabilizer is selected from the group consisting of a modified starch, gum acacia, maltodextrin, sugars, polyhydric alcohol and mixtures thereof.

4. The method of claim 1 wherein temperature outside the vacuum sealed bag containing the spray-dried citrus flavor is an elevated temperature of about 40° C.

5. The method of claim 1 wherein the humidity outside the vacuum sealed bag containing the spray-dried citrus flavor is from about 30% to about 100%.

6. The method of claim 1 wherein the low humidity environment inside the vacuum sealed bag is from about 0.1% to about 25% relative humidity.

7. The method of claim 1 wherein sodium carboxymethylcellulose is mixed with the spray dried flavor.

8. The method of claim 1 wherein the extended period of time is from about six to about twenty four weeks.

9. The method of claim 1 wherein the level of perceived off-flavor intensity contributed by the oxidation compounds selected from the group consisting off limonene oxide, carveol and carvone is below sensory significance.

10. The method of claim 1 wherein the level of limonene oxide is less than about 400 ppm/gm of oil.

11. The method of claim 1 wherein the level of carveol is less than about 250 ppm/gm oil.

12. The method of claim 1 wherein the level of carvone is less than about 200 ppm/gm oil

13. A method of maintaining the flavor stability in a powder soft drink comprising mixing a vacuum sealed spray-dried citrus flavor with a powder soft drink mix.

14. The method of claim 13 wherein the powder soft drink remains stable after a storage period of twenty four weeks.

15. The method of claim 13 wherein the level of perceived off-flavor intensity contributed by the oxidation compounds selected from the group consisting off limonene oxide, carveol and carvone is below sensory significance.

16. The method of claim 13 wherein the level of limonene oxide is less than about 400 ppm/gm of oil.

17. The method of claim 13 wherein the level of carveol is less than about 250 ppm/gm oil.

18. The method of claim 13 wherein the level of carvone is less than about 200 ppm/gm oil

19. A shelf-stable powdered soft drink comprising a vacuum sealed spray-dried flavor.

20. The shelf-stable powdered soft drink of claim 19 wherein the spray-dried citrus flavor comprises a citrus flavor, sugar and a stabilizer.

21. The shelf-stable powdered soft drink of claim 19 wherein the stabilizer is selected from the group consisting of a modified starch, gum acacia, maltodextrin, sugars, polyhydric alcohol and mixtures thereof.

22. The shelf-stable powdered soft drink of claim 19 wherein temperature outside the vacuum sealed bag containing the spray-dried citrus flavor is an elevated temperature of about 40° C.

23. The shelf-stable powdered soft drink of claim 19 wherein the humidity outside the vacuum sealed bag containing the spray-dried citrus flavor is from about 30% to about 100%.

24. The shelf-stable powdered soft drink of claim 19 wherein the low humidity environment inside the vacuum sealed bag is from about 0.1% to about 25% relative humidity.

25. The shelf-stable powdered soft drink of claim 19 wherein the level of spray-dried flavor is from about 0.01% to about 5% by weight.

26. The shelf stable powdered soft drink of claim 19 wherein the spray-dried flavor remains stable in the powdered soft drink during a twenty four week storage period.

27. The shelf stable powdered soft drink of claim 19 wherein the level of perceived off-flavor intensity contributed by the oxidation compounds selected from the group consisting off limonene oxide, carveol and carvone is below sensory significance.

28. The shelf stable powdered soft drink of claim 19 wherein the level of limonene oxide is less than about 400 ppm/gm of oil.

29. The shelf stable powdered soft drink of claim 19 wherein the level of carveol is less than about 250 ppm/gm oil.

30. The shelf stable powdered soft drink of claim 19 wherein the level of carvone is less than about 200 ppm/gm oil

31. The shelf stable powdered soft drink of claim 19 where in the spray-dried flavor is premixed with sodium carboxymethylcellulose.
